(19) United States
(12) Patent Application Publication
(10) Pub. No.: US 2011/0305802 A1
(43) Pub. Date: Dec. 15, 2011

(54) BREADING AND BATTER SYSTEMS AND METHODS TO PREPARE AND USE THE SAME

(76) Inventors: Gerry A. Hays, Carmel, IN (US); Geff A. Hays, Indianapolis, IN (US)

(21) Appl. No.: 13/161,323

(22) Filed: Jun. 15, 2011

Related U.S. Application Data
(60) Provisional application No. 61/355,039, filed on Jun. 15, 2010.

(51) Int. Cl. A21D 10/04; B65D 85/00

(52) U.S. Cl. 426/87; 426/124; 426/291; 426/392; 426/383

(57) ABSTRACT

Breading and batter systems and methods to prepare and use the same. In at least one embodiment of a breading and batter system of the present disclosure, the system comprises at least one first package containing a known quantity of a breading, at least one second package containing a known quantity of a batter mix, wherein the known quantity of a breading and the known quantity of a batter mix are intended for consumption at a corresponding rate, and a third package sized and shaped to receive the at least one first package and the at least one second package, the third package configured to be transported commercially without damage to the at least one first package or the at least one second package.

### PRIORITY

The present U.S. Nonprovisional Patent Application is related to, and claims the priority benefit of, U.S. Provisional Patent Application Ser. No. 61/355,039, filed Jun. 15, 2010, the contents of which are hereby incorporated by reference in their entirety into this disclosure.

### BACKGROUND

There are several ways to prepare and stage uncooked poultry for a deep fryer. For example, one common preparation method is a breading and batter process that requires that the preparer place the raw poultry in a breading (a seasoned flour, for example), then place the poultry in a batter, then again place the poultry the breading, and then onto a staging tray before being placed in a deep fryer.

For retail/commercial establishments, breading is typically provided in bulk containers. The dry batter mix comes in its own bulk container. The preparer must add water to the dry batter mix to make a batter prior to executing the aforementioned process.

There are specific challenges to the way the breading and batter mix are packaged and shipped to retail locations. First, the fact that a preparer must properly measure the amount of batter mix and water creates the potential for inconsistent batter and, ultimately, an inconsistent finished product. Second, the preparer does not know how much flour should be used with the batter before the batter should be replaced, creating the potential of food-borne illnesses due to expired/spoiled batter. Third, the preparer may prematurely throw away the batter mix, creating a product shrinkage issues. Fourth, retailers find it challenging to manage the process of inventorying the proper amounts of flour and batter mix, creating the potential for large carrying costs. As such, a pre-packaged two-step product, namely a bread and batter system, that overcomes each of these challenges would be well received in the marketplace.

### BRIEF SUMMARY

In at least one embodiment of a breading and batter system of the present disclosure, the system comprises at least one first package containing a known quantity of a breading, at least one second package containing a known quantity of a batter mix, wherein the known quantity of a breading and the known quantity of a batter mix are intended for consumption at a corresponding rate, and a third package sized and shaped to receive the at least one first package and the at least one second package, the third package configured to be transported commercially without damage to the at least one first package and/or the at least one second package. In another embodiment, the breading comprises a flour. In yet another embodiment, the breading further comprises at least one seasoning. In an additional embodiment, the at least one first package comprises one first package, and wherein the at least one second package comprises one second package.

In at least one embodiment of a breading and batter system of the present disclosure, a ratio of the at least one first package to the at least one second package within the third package corresponding to quantities of first and second packages is selected from the group consisting of 3:1, 2:1, 1:1, 1:2, and 1:3. In an additional embodiment, the at least one first package comprises at least one first plastic bag, and wherein the at least one second package comprises at least one second plastic bag. In yet an additional embodiment, the third package comprises a third plastic bag. In another embodiment, the third package comprises a box.

In at least one embodiment of a breading and batter system of the present disclosure, the system further comprises instructions for intended use of the known quantity of a breading and the known quantity of a batter mix, said instructions provided within and/or upon the third package. In another embodiment, the consumption at a corresponding rate relates to the use of the known quantity of a breading and the known quantity of a batter mix by way of applying the same to poultry.

In at least one embodiment of a method for staging a food product of the present disclosure, the method comprising the steps of removing at least one first package and at least one second package from a third package, at least substantially emptying a known quantity of a breading from the at least one first package into a first container, at least substantially emptying a known quantity of a batter mix from the at least one second package into a second container, introducing a known quantity of a liquid into the second container, mixing the known quantity of a batter mix and the known quantity of a liquid to form a batter, placing a quantity of a food product into the first container so that at least some of the known quantity of a breading contacts the quantity of a food product, transferring the quantity of a food product into the second container to at least substantially coat the quantity of a food product with the batter, and transferring the quantity food product into the first container to at least substantially coat the quantity of a food product with some of the known quantity of a breading after the quantity of food product has been at least substantially coated with the batter. In another embodiment, the method further comprises the step of transferring the quantity of food product onto a first tray. In yet another embodiment, the method further comprises the steps of transferring the quantity food product into a quantity of heated oil, and removing the quantity of food product from the quantity of heated oil after a desired amount of time has lapsed. In an additional embodiment, the method further comprises the step of placing the food product onto a second tray.

In at least one embodiment of a method for staging a food product of the present disclosure, the step of placing a quantity of a food product into the first container is performed by placing a quantity of poultry into the first container. In an additional embodiment, the method further comprises the steps of upon consumption of all or substantially all of the known quantity of breading and/batter, discarding any remaining breading or batter, removing at least one additional first package and at least one additional second package from the third package, at least substantially emptying a known additional quantity of breading from the at least one additional first package into the first container, at least substantially emptying a known additional quantity of batter mix from the at least one additional second package into the second container, introducing an additional known quantity of a liquid into the second container, and mixing the known additional quantity of batter mix and the additional known quantity of liquid to form additional batter. In yet an additional embodiment, the method further comprises the steps of placing an additional quantity of food product into the first container so that at least some of the known additional quantity of an additional first ingredient contacts the additional quantity of food product, transferring the additional quantity of food product into the second container so that least some of the additional batter contacts the additional quantity food product, and transferring the additional quantity of food product into the first container so that at least some of the known additional quantity of an additional first ingredient contacts the additional quantity of food product after the additional quantity of food product as contacted the additional batter.

In at least one embodiment of a method for preparing a pre-packaged two-step product of the present disclosure, the method comprising the steps of placing a known quantity of a breading into at least one first package, placing a known quantity of a batter mix into at least one second package, wherein the known quantity of a breading and the known quantity of a batter mix are intended for consumption at a corresponding rate, sealing the at least one first package and the at least one second package, and enclosing the at least one first package and the at least one second package into a third package, the third package configured to be transported commercially without damage to the at least one first package and/or the at least one second package. In another embodiment, the method further comprises the step of transporting the third package from a first location ultimately to a second location, wherein at least part of the known quantity of a breading and at least part of the known quantity of a batter mix will be consumed at the second location. In another embodiment, the step of placing a known quantity of a breading into at least one first package is performed by transferring the known quantity of a breading into the least one first package from a first supply container containing a supply of breading, and wherein the step of placing a known quantity of a batter mix into at least one second package is performed by transferring the known quantity of a batter mix into the least one second package from a second supply container containing a supply of batter mix. In an additional embodiment the sealing step comprises heat-sealing the at least one first package and the at least one second package. In yet an additional embodiment, the method further comprises the step of providing instructions for intended use of the breading and the batter mix within and/or upon the third package.

In at least one embodiment of a breading and batter system of the present disclosure, the system comprises at least one first package containing a known quantity of a first ingredient, at least one second package containing a known quantity of a second ingredient, wherein the known quantity of a first ingredient and the known quantity of a second ingredient are intended for consumption at a corresponding rate, and a third package sized and shaped to receive the at least one first package and the at least one second package. In another embodiment, the first ingredient comprises a breading. In yet another embodiment, the breading comprises a flour. In an additional embodiment, the breading further comprises at least one seasoning.

In at least one embodiment of a breading and batter system of the present disclosure, the second ingredient comprises a batter mix. In an additional embodiment, the at least one first package comprises one first package, and wherein the at least one second package comprises one second package. In yet an additional embodiment, the at least one first package comprises two first packages, and wherein the at least one second package comprises two second packages. In another embodiment, the at least one first package comprises at least three first packages, and wherein the at least one second package comprises at least three second packages.

In at least one embodiment of a breading and batter system of the present disclosure, the at least one first package comprises one first package, and wherein the at least one second package comprises two second packages. In another embodiment, the at least one first package comprises two first packages, and wherein the at least one second package comprises one second package. In yet another embodiment, the at least one first package comprises six first packages, and wherein the at least one second package comprises three second packages. In an additional embodiment, the at least one first package and the at least one second package are provided in at ratio of 2:1 within the third package.

In at least one embodiment of a breading and batter system of the present disclosure, the at least one first package comprises at least one first plastic bag, and wherein the at least one second package comprises at least one second plastic bag. In an additional embodiment, the third package comprises a third plastic bag. In yet an additional embodiment, the third package comprises a box. In another embodiment, the third package is capable of being transported commercially without damage.

In at least one embodiment of a breading and batter system of the present disclosure, the system further comprises instructions for intended use of the known quantity of a first ingredient and the known quantity of a second ingredient, said instructions provided within and/or upon the third package. In another embodiment, the consumption at a corresponding rate relates to the use of the known quantity of the first ingredient and the known quantity of the second ingredient by way of applying the same to poultry.

In at least one embodiment of a breading and batter system of the present disclosure, the system comprises at least one first plastic package containing a known quantity of a breading, at least one second plastic package containing a known quantity of a batter mix, wherein the known quantity of a breading and the known quantity of a batter mix are intended for consumption at a corresponding rate, a third package sized and shaped to receive the at least one first plastic package and the at least one second plastic package, wherein the third package is capable of being transported commercially without damage, and instructions for intended use of the known quantity of a first ingredient and the known quantity of a second ingredient, said instructions provided within and/or upon the third package.

In at least one embodiment of a method for staging a food product of the present disclosure, the method comprises the steps of removing at least one first package and at least one second package from a third package, at least substantially emptying a known quantity of a first ingredient from the at least one first package into a first container, at least substantially emptying a known quantity of a second ingredient from the at least one second package into a second container, introducing a known quantity of a liquid into the second container, mixing the known quantity of a second ingredient and the known quantity of a liquid to form a batter, placing a food product into the first container so that at least some of the known quantity of a first ingredient contacts the food product, transferring the food product into the second container so that least some of the batter contacts the food product, and transferring the food product into the first container so that at least some of the known quantity of a first ingredient contacts the food product after the food product as contacted the batter. In another embodiment, the method further comprises the step of transferring the food product onto a first tray. In yet another embodiment, the method further comprises the steps of transferring the food product into a quantity of heated oil, and removing the food product from the quantity of heated oil after a desired amount of time has lapsed. In an additional embodiment, the method further comprises the step of placing the food product onto a second tray.

In at least one embodiment of a method for staging a food product of the present disclosure, the first ingredient comprises breading, and wherein the second ingredient comprises batter mix. In an additional embodiment, the liquid comprises water. In yet an additional embodiment, the food product comprises poultry.

In at least one embodiment of a method for staging a food product of the present disclosure, the method further comprises the steps of upon consumption of all or substantially all of the known quantity of a first ingredient or the known quantity of a second ingredient, discarding any remaining first ingredient or second ingredient, removing at least one additional first package and at least one additional second package from the third package, at least substantially emptying a known additional quantity of an additional first ingredient from the at least one additional first package into the first container, at least substantially emptying a known additional quantity of an additional second ingredient from the at least one additional second package into the second container, introducing an additional known quantity of liquid into the second container, and mixing the known additional quantity of an additional second ingredient and the additional known quantity of liquid to form additional batter. In another embodiment, the method further comprises the steps of placing additional food product into the first container so that at least some of the known additional quantity of an additional first ingredient contacts the additional food product, transferring the additional food product into the second container so that least some of the additional batter contacts the additional food product, and transferring the additional food product into the first container so that at least some of the known additional quantity of an additional first ingredient contacts the additional food product after the additional food product as contacted the additional batter. In yet another embodiment, the method further comprises the step of transferring the additional food product onto a first tray.

In at least one embodiment of a method for preparing a pre-packaged two-step product of the present disclosure, the method comprising the steps of placing a known quantity of a first ingredient into at least one first package, placing a known quantity of a second ingredient into at least one second package, wherein the known quantity of a first ingredient and the known quantity of a second ingredient are intended for consumption at a corresponding rate, sealing the at least one first package and the at least one second package, and enclosing the at least one first package and the at least one second package into a third package. In another embodiment, the method further comprises the step of transporting the third package from a first location ultimately to a second location, wherein at least part of the known quantity of a first ingredient and at least part of the known quantity of a second ingredient will be consumed at the second location. In yet another embodiment, the step of placing a known quantity of a first ingredient into at least one first package is performed by transferring the known quantity of a first ingredient into the least one first package from a first supply container containing a supply of a first ingredient. In an additional embodiment, the step of placing a known quantity of a second ingredient into at least one second package is performed by transferring the known quantity of a second ingredient into the least one second package from a second supply container containing a supply of a second ingredient. In an additional embodiment, the sealing step comprises heat-sealing the at least one first package and the at least one second package. In another embodiment, the method further comprises the step of providing instructions for intended use of the first ingredient and the second ingredient within and/or upon the third package.

In at least one embodiment of a method of consistently preparing staged poultry, the method comprises the steps of removing at least one first package and at least one second package from a third package, at least substantially emptying a known quantity of breading from the at least one first package into a first container, at least substantially emptying a known quantity of batter mix from the at least one second package into a second container, introducing a known quantity of water into the second container, mixing the known quantity of batter mix and the known quantity of water to form a batter, placing a quantity of poultry into the first container to at least substantially coat the quantity of poultry with some of the known quantity, of breading, transferring the quantity of poultry into the second container to at least substantially coat the quantity of poultry with the batter, and transferring the quantity of poultry into the first container to at least substantially coat the quantity of poultry with some of the known quantity of breading after the quantity of poultry has been at least substantially coated with batter. In another embodiment, the method further comprises the step of transferring the quantity of poultry onto a first tray. In yet another embodiment, the method further comprises the steps of transferring the quantity of poultry into a quantity of heated oil, and removing the quantity of poultry from the quantity of heated oil after a desired amount of time has lapsed. In an additional embodiment, the method further comprises the step of placing the quantity of poultry onto a second tray.

In at least one embodiment of a method of consistently preparing staged poultry, the method further comprises the steps of upon consumption of all or substantially all of the known quantity of breading and/batter, discarding any remaining breading or batter, removing at least one additional first package and at least one additional second package from the third package, at least substantially emptying a known additional quantity of breading from the at least one additional first package into the first container, at least substantially emptying a known additional quantity of batter mix from the at least one additional second package into the second container, introducing an additional known quantity of water into the second container, and mixing the known additional quantity of batter mix and the additional known quantity of water to form additional batter. In an additional embodiment, the method further comprises the steps of placing an additional quantity of poultry into the first container to at least substantially coat the additional quantity of poultry with some of the additional quantity of breading, transferring the quantity of poultry into the second container to at least substantially coat the additional quantity of poultry with the additional batter, and transferring the quantity of poultry into the first container to at least substantially coat the additional quantity of poultry with some of the additional quantity of breading after the quantity of poultry has been at least substantially coated with batter. In yet an additional embodiment, the method further comprises the step of transferring the additional quantity of poultry onto a second tray.

In at least one embodiment of a method of consistently preparing staged poultry of the present disclosure, the method comprising the steps of removing two first packages and at least one second package from a third package, at least substantially emptying a known quantity of breading from one of the two first packages into a first container, at least substantially emptying a known quantity of batter mix from the at least one second package into a second container, at least substantially emptying a known quantity of breading from the second of the two first packages into a third container, introducing a known quantity of water into the second container, mixing the known quantity of batter mix and the known quantity of water to form a batter, placing a quantity of poultry into the first container to at least substantially coat the quantity of poultry with some of the known quantity of breading, transferring the quantity of poultry into the second container to at least substantially coat the quantity of poultry with the batter, and transferring the quantity of poultry into the third container to at least substantially coat the quantity of poultry with some of the known quantity of breading after the quantity of poultry has been at least substantially coated with batter.

In at least one embodiment of a method of doing business of the present disclosure, the method comprising the steps of preparing a breading and batter system at a first location, the breading and batter system provided within a single package, and transporting the single package from the first location ultimately to a second location, wherein at least part of the breading and batter system within the single package will be consumed at the second location. another embodiment, the method further comprises the step of consuming at least part of the breading and batter system within the single package at the second location during the preparation of fried poultry.

### BRIEF DESCRIPTION OF THE DRAWINGS

FIGS. 1A and 1B show breading and batter systems, according to exemplary embodiments of the present disclosure;

FIG. 1C shows containers used with ingredients of exemplary breading and batter systems, according to an exemplary embodiment of the present disclosure;

FIG. 2 shows steps of a method for staging a food product, according to an exemplary embodiment of the present disclosure;

FIG. 3 shows steps of a method for preparing a pre-packaged two-step product, according to an exemplary embodiment of the present disclosure;

FIGS. 4A and 4B show steps of exemplary methods for consistently preparing staged poultry, according to exemplary embodiments of the present disclosure; and

FIG. 5 shows steps of a method of doing business, according to an exemplary embodiment of the present disclosure.

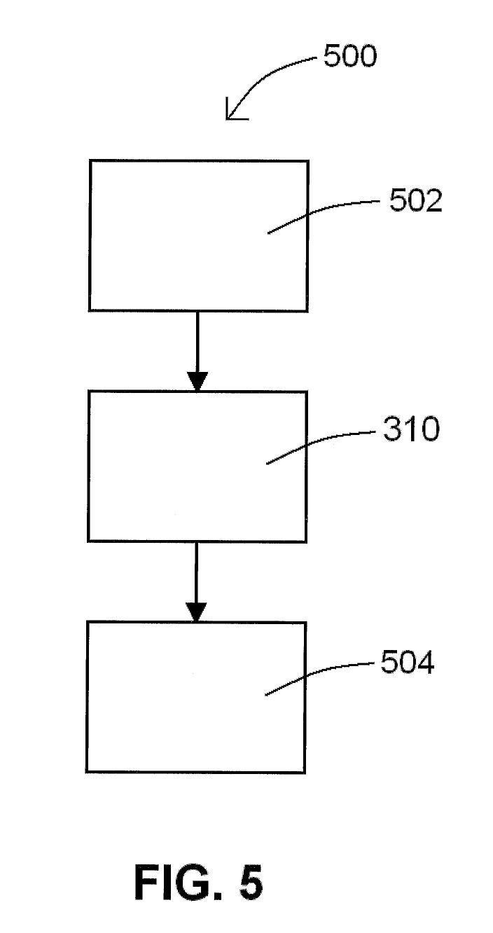

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As referenced in detail herein, various breading and batter systems of the present disclosure are provided in a single package for use at a retail location. Such systems include, for example, individual bags of breading and individual bags of batter mix. A preparer of poultry, for example, will be instructed to open a single bag of batter mix and add a specific amount of water to form a batter. The preparer will then open a bag of breading for use with the batter mix. Once the breading is exhausted, the preparer will then dispose of the batter and prepare new batter. Each system container will contain ingredients to, for example, consistently bread and batter a specific amount of raw poultry.

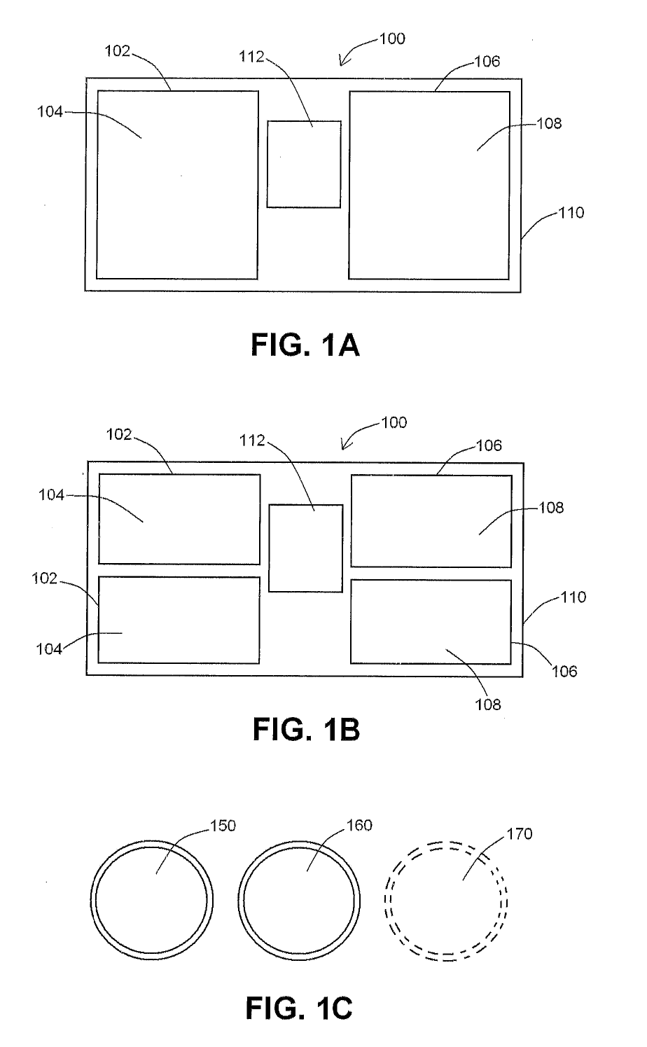

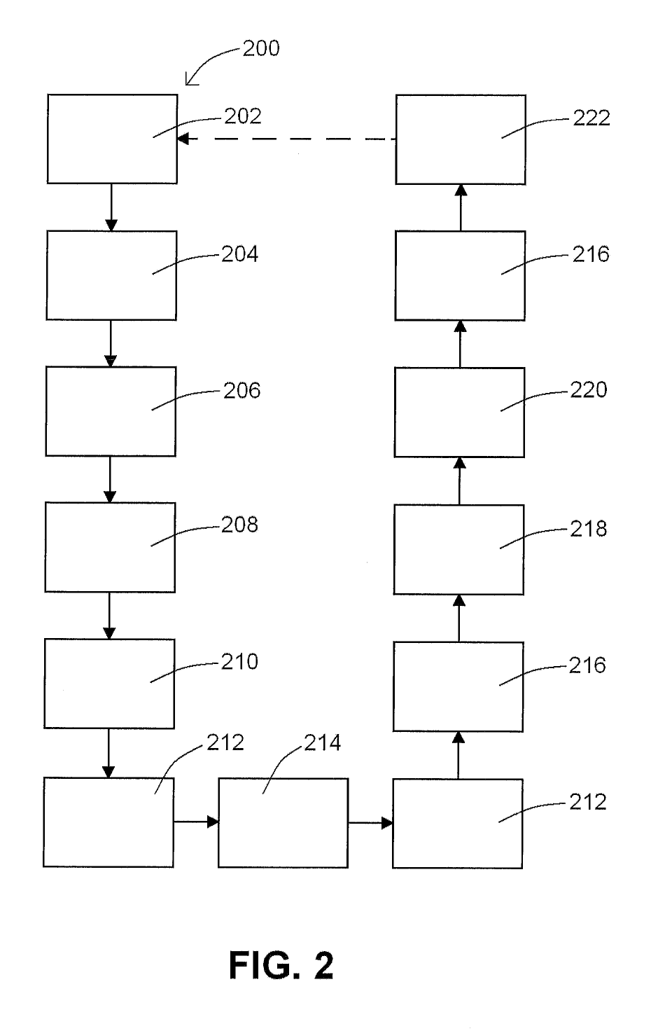

An exemplary embodiment of a breading and batter system of the present disclosure is shown in FIG. 1A. As shown in FIG. 1A, breading and batter system 100 (also referred to herein as a system 100 and/or a pre-packaged two-step product) comprises at least one first package 102 containing a known quantity of a first ingredient 104, and further comprises at least one second package 106 containing a known quantity of a second ingredient 108, wherein the known quantity of a first ingredient 104 and the known quantity of a second ingredient 108 are intended for consumption at a corresponding rate. System 100, in various embodiments, further comprises a third package 110 sized and shaped to receive first package 102 and second package 106.

In various embodiments, first ingredient 104 comprises a breading, which itself may be a flour, a seasoned flour, and/or any number of commercially available breadings and/or seasonings for use with, for example, staging poultry. In various embodiments, the breading further comprises at least one seasoning. In at least one exemplary embodiment, second ingredient 108 comprises a batter mix, which itself may be provided in dry form and mixed with water and/or other liquids or ingredients to prepare a batter.

Various quantities of first packages 102 and second packages 106 may comprise exemplary systems of the present disclosure. As shown in the exemplary embodiment of a system 100 shown in FIG. 1A, system 100 comprises one first package 102 and one second package 104. As shown in FIG. 1B, an exemplary system 100 may comprise two first packages 102 and two second packages 106. Various other configurations/quantities of packages may be made, including, but not limited to, (i) at least three first packages 102 and at least three second packages 106, (ii) one first package 102 and two second packages 106; (iii) two first packages 102 and one second package 106, and (iv) six first packages 102 and three second packages 106. In at least one embodiment, system 100 comprises a 2:1 ratio of first packages 102 and second package(s) 106. The present disclosure is not limited to any particular configuration/quantity of first packages 102 and/or second packages 106 within third package 110. At least one benefit of the various quantities of first packages 102 and second packages 106 within system 100 relates to contamination prevention and/or spoilage due to open food packaging, as in at least one embodiment, less than all of the first packages 102 and the second packages 106 within a particular system 100 would be used at one time, allowing remaining ingredients within said packages to remain sealed, uncontaminated, and unspoiled.

In at least one exemplary embodiment of a system 100 of the present disclosure, first package 102 and second package 106 each comprise plastic bags. In various embodiments, third package 110 comprises a plastic bag or a box, whereby, for example, the plastic bags and/or boxes are capable of being transported commercially without damage,

As shown in FIGS. 1A and 1B, and in at least one embodiment, system 100 of the present disclosure further comprises instructions 112 for intended use of first ingredient 104 and second ingredient 108. Instructions 112 may, for example, be provided within and/or upon third package 110, including, but not limited to, being provided on and/or in first package 102 and/or second package 106.

In various embodiments, and as generally referenced herein, the consumption of first ingredient 104 and second ingredient 108 at a corresponding rate relates to the use of the same way of applying the same to poultry. For example, when staging a quantity of chicken legs, wings, breasts, and/or thighs, consistently staged chicken may be prepared using first ingredient 104 and second ingredient 108 because the quantities of ingredients are known and not estimated, the latter of which can lead to poorer quality or improperly staged chicken.

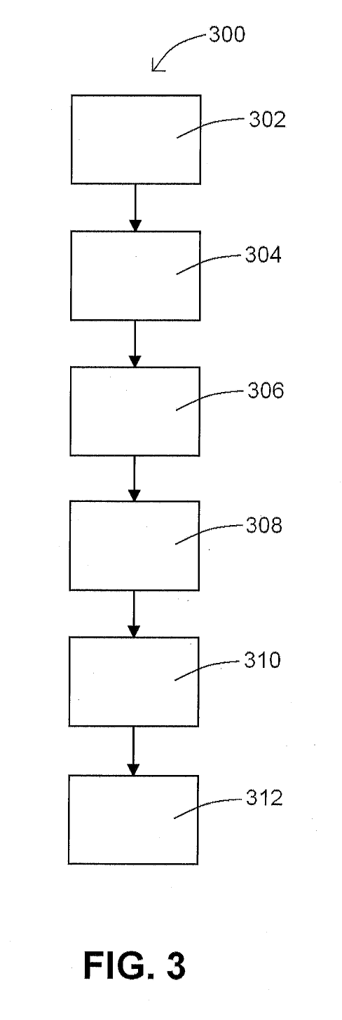

The present disclosure also discloses various methods for staging a food product. In at least one embodiment, and as shown by way of method steps in FIG. 2, method 200 comprises the steps of removing at least one first package 102 and at least one second package 104 from a third package 110 (an exemplary removal step 202), at least substantially emptying a known quantity of a first ingredient 104 from the at least one first package 102 into a first container 150 (an exemplary first package emptying step 204), and at least substantially emptying a known quantity of a second ingredient 108 from the at least one second package 106 into a second container 160 (an exemplary second package emptying step 206). An exemplary method 200 may further comprise the steps of introducing a known quantity of a liquid into the second container 160 (an exemplary liquid introduction step 208), and mixing the known quantity of a second ingredient 108 and the known quantity of a liquid to form a batter (an exemplary mixing step 210).

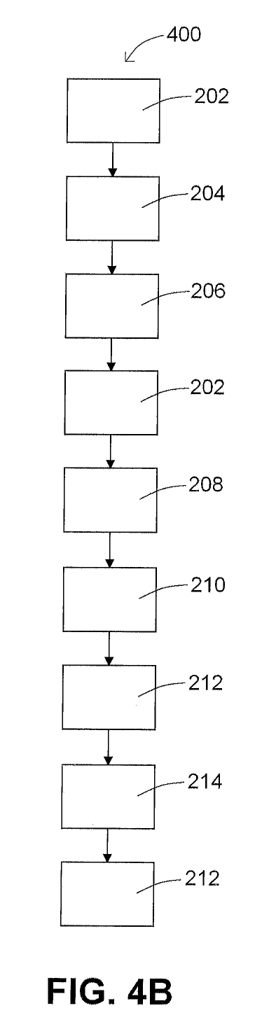

One or more of the aforementioned steps may be performed using, for example, the containers shown in FIG. 1C. As shown in FIG. 1C, a first container 150 may be used to receive first ingredient 104, and a second container 160 may be used to receive second ingredient 108 and a quantity of liquid. In at least one embodiment, and as referenced within the method steps shown in FIG. 4B, an optional third container 170 may be used to receive first ingredient 104 as well, so that when poultry is staged in accordance with the present application, it may be staged by being transferred, for example, from first container 150 to second container 160 back to first container 150, or it may be staged by being transferred from first container 150 to second container 160 to third container 170.

Referring back to FIG. 2, and in various embodiments, methods 200 of the present disclosure further comprise the steps of placing a food product into the first container 150 so that at least some of the known quantity of a first ingredient 104 contacts the food product (an exemplary first product introduction step 212), transferring the food product into the second container 160 so that least some of the batter contacts the food product (an exemplary second product introduction step 214), and transferring the food product into the first container 150 so that at least some of the known quantity of a first ingredient 104 contacts the food product after the food product as contacted the batter (another exemplary first product introduction step 212). In various embodiments, methods 200 of the present disclosure also comprise the steps of transferring the food product onto a first tray (an exemplary tray transfer step 216), transferring the food product into a quantity of heated oil (an exemplary oil transfer step 218), and removing the food product from the quantity of heated oil after a desired amount of time has lapsed (an exemplary oil removal step 220). Various methods 200 of the present disclosure may further comprise the step of placing the food product onto a second tray (another exemplary tray transfer step 216).

In various methods 200 of the present disclosure, the first ingredient 104 comprises breading, and the second ingredient 108 comprises batter mix. In at least one embodiment, liquid introduction step 208 comprises introducing water to the batter mix, which may be in any particular quantity, such as, for example, one, two, or three gallons. In various embodiments, the food product comprises poultry.

In at least one embodiment of a method 200 of the present disclosure, and as shown in FIG. 2, method 200 may further comprise one or more of the steps of, upon consumption of all or substantially all of the known quantity of a first ingredient 104 or the known quantity of a second ingredient 108, discarding any remaining first ingredient or second ingredient (an exemplary discard step 222), removing at least one additional first package 102 and at least one additional second package 106 from the third package 110 (another exemplary removal step 202), at least substantially emptying a known additional quantity of an additional first ingredient 104 from the at least one additional first package 102 into the first container 150 (another exemplary first package emptying step 204), and at least substantially emptying a known additional quantity of an additional second ingredient 108 from the at least one additional second package 106 into the second container 160 (another exemplary second package emptying step 206). Exemplary methods 200 may further comprise the steps of introducing an additional known quantity of liquid into the second container 160 (another exemplary liquid introduction step 208), and mixing the known additional quantity of an additional second ingredient 108 and the additional known quantity of liquid to form additional batter (another exemplary mixing step 210).

Various methods 200 of the present disclosure, as shown in FIG. 2, may then further comprise the steps of placing additional food product into the first container 150 so that at least some of the known additional quantity of an additional first ingredient 104 contacts the additional food product (another exemplary first product introduction step 212), transferring the additional food product into the second container 160 so that least some of the additional batter contacts the additional food product (another exemplary second product introduction step 214), and transferring the additional food product into the first container 150 so that at least some of the known additional quantity of an additional first ingredient 104 contacts the additional food product after the additional food product as contacted the additional batter (another exemplary first product introduction step 212). In at least one embodiment, method 200 further comprises the step of transferring the additional food product onto a first tray (another exemplary tray transfer step 216). As is shown above, one or more of the various steps of exemplary methods 200 may be repeated to stage additional quantities of food product.

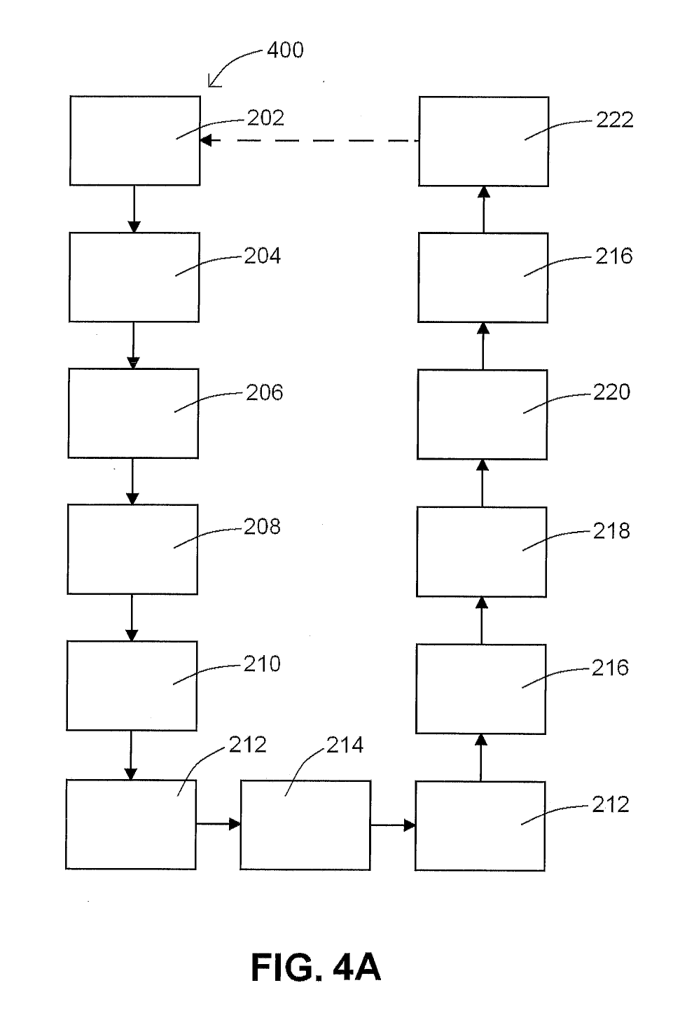

The present disclosure also discloses various methods for preparing a pre-packaged two-step product. In at least one method for preparing a pre-packaged two-step product 300 of the present disclosure, and as shown in FIG. 3, method 300 comprises the steps of placing a known quantity of a first ingredient 104 into at least one first package 102 (an exemplary first ingredient packaging step 302), placing a known quantity of a second ingredient 108 into at least one second package 106, wherein the known quantity of a first ingredient 104 and the known quantity of a second ingredient 108 are intended for consumption at a corresponding rate (an exemplary second ingredient packaging step 304), sealing the at least one first package 104 and the at least one second package 108 (an exemplary sealing step 306), and enclosing the at least one first package 104 and the at least one second package 108 into a third package 110 (an exemplary enclosure step 308). In at least one embodiment, method 300 further comprises the step of transporting the third package 110 from a first location ultimately to a second location, wherein at least part of the known quantity of a first ingredient 104 and at least part of the known quantity of a second ingredient 108 will be consumed at the second location (an exemplary transportation step 310).

In at least one embodiment, first ingredient packaging step 302 is performed by transferring the known quantity of a first ingredient 104 into the least one first package 102 from a first supply container containing a supply of a first ingredient. In an additional embodiment, second ingredient packaging step 304 is performed by transferring the known quantity of a second ingredient 108 into the least one second package 106 from a second supply container containing a supply of a second ingredient. In various embodiments, sealing step 306 comprises heat-sealing the at least one first package 102 and the at least one second package 106. In at least one embodiment, method 300 further comprises the step of providing instructions 112 for intended use of the first ingredient 104 and the second ingredient 108 within and/or upon the third package 110 (an exemplary instruction providing step 312).

Various embodiments of methods of consistently preparing staged poultry are also provided within the present disclosure. As shown in FIG. 4A, at least one exemplary method of consistently preparing staged poultry 400 of the present disclosure comprises the steps of removing at least one first package 102 and at least one second package 106 from a third package 110 (another exemplary removal step 202), at least substantially emptying a known quantity of breading from the at least one first package 102 into a first container 150 (another exemplary first package emptying step 204), at least substantially emptying a known quantity of batter mix from the at least one second package 108 into a second container 160 (another exemplary second package emptying step 206), introducing a known quantity of water into the second container 160 (another exemplary liquid introduction step 208), and mixing the known quantity of batter mix and the known quantity of water to form a batter (another exemplary mixing step 210).

Exemplary methods 400 of the present disclosure may further comprise the steps of placing a quantity of poultry into the first container 150 to at least substantially coat the quantity of poultry with some of the known quantity of breading (another first product introduction step 212), transferring the quantity of poultry into the second container 160 to at least substantially coat the quantity of poultry with the batter (another exemplary second product introduction step 214), and transferring the quantity of poultry into the first container 150 to at least substantially coat the quantity of poultry with some of the known quantity of breading after the quantity of poultry has been at least substantially coated with batter (another exemplary first product introduction step 212). In at least one embodiment, method 400 further comprises the step of transferring the quantity of poultry onto a first tray (another exemplary tray transfer step 216).

In various embodiments of methods 400 of the present disclosure, and as shown in FIG. 4A, methods 400 may further comprise the steps of transferring the quantity of poultry into a quantity of heated oil (another exemplary oil transfer step 218), removing the quantity of poultry from the quantity of heated oil after a desired amount of time has lapsed (another exemplary oil removal step 220), and placing the quantity of poultry onto a second tray (another exemplary tray transfer step 216). In at least one embodiment of a method 400 of the present disclosure, method 400 may then further comprise the steps of, upon consumption of all or substantially all of the known quantity of breading and/batter, discarding any remaining breading or batter (another exemplary discard step 222), removing at least one additional first package 102 and at least one additional second package 106 from the third package 110 (another exemplary removal step 202), at least substantially emptying a known additional quantity of breading from the at least one additional first package 102 into the first container 150 (another, exemplary first package emptying step 204), at least substantially emptying a known additional quantity of batter mix from the at least one additional second package 106 into the second container 160 (another exemplary second package emptying step 206), introducing an additional known quantity of water into the second container 160 (another exemplary liquid introduction step 208), and mixing the known additional quantity of batter mix and the additional known quantity of water to form additional batter (another exemplary mixing step 210).

In at least one embodiment of a method 400 of the present disclosure, and as shown in FIG. 4A, method 400 may further comprise the steps of placing an additional quantity of poultry into the first container 150 to at least substantially coat the additional quantity of poultry with some of the additional quantity of breading (another exemplary first product introduction step 212), transferring the quantity of poultry into the second container 160 to at least substantially coat the additional quantity of poultry with the additional batter (another exemplary second product introduction step 214), and transferring the quantity of poultry into the first container 150 to at least substantially coat the additional quantity of poultry with some of the additional quantity of breading after the quantity of poultry has been at least substantially coated with batter (another exemplary first product introduction step 212). In various embodiments of methods 400 of the present disclosure, methods 400 may further comprise the step of transferring the additional quantity of poultry onto a second tray (another exemplary tray transfer step 216).

In another exemplary embodiment of a method of consistently preparing staged poultry 400 of the present disclosure, and as shown in FIG. 4B, method 400 comprises the steps of removing two first packages 102 and at least one second package 106 from a third package (another exemplary removal step 202), at least substantially emptying a known quantity of breading from one of the two first packages 102 into a first container 150 (another exemplary first package emptying step 204), at least substantially emptying a known quantity of batter mix from the at least one second package 106 into a second container 160 (another exemplary second package emptying step 206), at least substantially emptying a known quantity of breading from the second of the two first packages 102 into a third container 170 (another exemplary first package emptying step 202), introducing a known quantity of water into the second container 160 (another exemplary liquid introduction step 208), mixing the known quantity of batter mix and the known quantity of water to form a batter (another exemplary mixing step 210), placing a quantity of poultry into the first container 150 to at least substantially coat the quantity of poultry with some of the known quantity of breading (another exemplary first product introduction step 212), transferring the quantity of poultry into the second container 160 to at least substantially coat the quantity of poultry with the batter (another exemplary second product introduction step 214), and transferring the quantity of poultry into the third container 170 to at least substantially coat the quantity of poultry with some of the known quantity of breading after the quantity of poultry has been at least substantially coated with batter (another exemplary first product introduction step 212). Method 400, as shown in FIG. 4B, may further comprise one or more of the steps shown in FIG. 4A and described herein.

Various methods of doing business are also disclosed herein. In at least one exemplary embodiment of a method of doing business 500 of the present disclosure, method 500 comprises the steps of preparing a breading and batter system 100 at a first location, the breading and batter system provided within a single package (an exemplary system preparation step 502), and transporting the single package from the first location ultimately to a second location, wherein at least part of the breading and batter system 100 within the single package will be consumed at the second location (another exemplary transportation step 310). In at least one embodiment, method 500 further comprises the step of consuming at least part of the breading and batter system 100 within the single package at the second location during the preparation of fried poultry (an exemplary consumption step 504).

While various embodiments of breading and batter systems and methods to prepare and use the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A breading and batter system, the system comprising:
at least one first package containing a known quantity of a breading;
at least one second package containing a known quantity of a batter mix, wherein the known quantity of a breading and the known quantity of a batter mix are intended for consumption at a corresponding rate; and
a third package sized and shaped to receive the at least one first package and the at least one second package, the third package configured to be transported commercially without damage to the at least one first package and/or the at least one second package.

2. The system of claim 1, wherein the breading comprises a flour.

3. The system of claim 2, wherein the breading further comprises at least one seasoning.

4. The system of claim 1, wherein the at least one first package comprises one first package, and wherein the at least one second package comprises one second package.

5. The system of claim 1, wherein a ratio of the at least one first package to the at least one second package within the third package corresponding to quantities of first and second packages is selected from the group consisting of 3:1, 2:1, 1:1, 1:2, and 1:3.

6. The system of claim 1, wherein the at least one first package comprises at least one first plastic bag, and wherein the at least one second package comprises at least one second plastic bag.

7. The system of claim 6, wherein the third package comprises a third plastic bag.

8. The system of claim 6, wherein the third package comprises a box.

9. The system of claim 1, further comprising:
instructions for intended use of the known quantity of a breading and the known quantity of a batter mix, said instructions provided within and/or upon the third package.

10. The system of claim 1, wherein the consumption at a corresponding rate relates to the use of the known quantity of a breading and the known quantity of a batter mix by way of applying the same to poultry.

11. A method for staging a food product, the method comprising the steps of:
removing at least one first package and at least one second package from a third package;
at least substantially emptying a known quantity of a breading from the at least one first package into a first container;
at least substantially emptying a known quantity of a batter mix from the at least one second package into a second container;
introducing a known quantity of a liquid into the second container;
mixing the known quantity of a batter mix and the known quantity of a liquid to form a batter;
placing a quantity of a food product into the first container so that at least some of the known quantity of a breading contacts the quantity of a food product;
transferring the quantity of a food product into the second container to at least substantially coat the quantity of a food product with the batter; and
transferring the quantity food product into the first container to at least substantially coat the quantity of a food product with some of the known quantity of a breading after the quantity of food product has been at least substantially coated with the batter.

12. The method of claim 11, further comprising the step of:
transferring the quantity of food product onto a first tray.

13. The method of claim 11, further comprising the steps of:
transferring the quantity food product into a quantity of heated oil; and
removing the quantity of food product from the quantity of heated oil after a desired amount of time has lapsed.

14. The method of claim 13, further comprising the step of:
placing the food product onto a second tray.

15. The method of claim 11, wherein the step of placing a quantity of a food product into the first container is performed by placing a quantity of poultry into the first container.

16. The method of claim 11, further comprising the steps of:
upon consumption of all or substantially all of the known quantity of breading and/batter, discarding any remaining breading or batter;
removing at least one additional first package and at least one additional second package from the third package;
at least substantially emptying a known additional quantity of breading from the at least one additional first package into the first container;
at least substantially emptying a known additional quantity of batter mix from the at least one additional second package into the second container;
introducing an additional known quantity of a liquid into the second container; and
mixing the known additional quantity of batter mix and the additional known quantity of liquid to form additional batter.

17. The method of claim 16, further comprising the steps of:
placing an additional quantity of food product into the first container so that at least some of the known additional quantity of an additional first ingredient contacts the additional quantity of food product;
transferring the additional quantity of food product into the second container so that least some of the additional batter contacts the additional quantity food product; and
transferring the additional quantity of food product into the first container so that at least some of the known additional quantity of an additional first ingredient contacts the additional quantity of food product after the additional quantity of food product as contacted the additional batter.

18. A method for preparing a pre-packaged two-step product, the method comprising the steps of:
placing a known quantity of a breading into at least one first package;
placing a known quantity of a batter mix into at least one second package, wherein the known quantity of a breading and the known quantity of a batter mix are intended for consumption at a corresponding rate;
sealing the at least one first package and the at least one second package; and
enclosing the at least one first package and the at least one second package into a third package, the third package configured to be transported commercially without damage to the at least one first package and/or the at least one second package.

19. The method of claim 18, further comprising the step of:
transporting the third package from a first location ultimately to a second location, wherein at least part of the known quantity of a breading and at least part of the known quantity of a batter mix will be consumed at the second location.

20. The method of claim 18, wherein the step of placing a known quantity of a breading into at least one first package is performed by transferring the known quantity of a breading into the least one first package from a first supply container containing a supply of breading, and wherein the step of placing a known quantity of a batter mix into at least one second package is performed by transferring the known quantity of a batter mix into the least one second package from a second supply container containing a supply of batter mix.

21. The method of claim 18, wherein the sealing step comprises heat-sealing the at least one first package and the at least one second package.

22. The method of claim 18, further comprising the step of:
providing instructions for intended use of the breading and the batter mix within and/or upon the third package.
